(19) United States
(12) Patent Application Publication
(10) Pub. No.: US 2004/0253104 A1
(43) Pub. Date: Dec. 16, 2004

(54) Fan blade-hoisting device for ceiling fan

(76) Inventor: Ching-Wen Liu, Feng Yuan City (TW)

Correspondence Address: CHARLES E. BAXLEY, ESQ., 90 JOHN STREET, THIRD FLOOR, NEW YORK, NY, 10038, US

(21) Appl. No.: 10/463,024

(22) Filed: Jun. 16, 2003

(51) Int. Cl. F03D 1/00; F03B 7/00; F04D 29/26

(52) U.S. Cl. 416/48

(57) ABSTRACT

A fan blade-hoisting device for ceiling fan comprises a fixed bracket and a revolving unit. Wherein the fixed bracket is fixed to the rotary assembly of the ceiling fan, the revolving unit is connected to the fixed bracket, which is revolvable relative to the fixed bracket, the revolving unit is combined with the fan blade. By such arrangements, the respective fan blade will be drop down in case of stoppage of the ceiling fan, such that enables the user to clean the fan blades easily without damaged caused, while the fan blades will be raised up so as to blow the air in case of the rotation of the ceiling fan.

### BACKGROUND OF THE INVENTION

1. Field of the Invention

The present invention relates to a fan blade-hoisting device, and more particularly to a hoisting device disposed between the respective blade and the rotary assembly so as to raise up the respective blade automatically during rotation of the same.

2. Description of the Prior Arts

A conventional ceiling fan generally comprises a motor, a rotary assembly combined with the motor and a plurality of fan blades coupling to the rotary assembly. Wherein the motor is external-rotor motor, thereby the cover disposed on the periphery of the motor will rotate so as to effect the rotation of the rotary assembly which fixed on the cover, as a result, the fan blades will be caused to rotate and blow the air.

During the rotation of above-mentioned ceiling fan, the respective fan blade has a windward side formed on the outer surface in a manner of inclined angle, or the fan blades are fixed in an inclined manner so as to form a windward side at the outer surface thereof, thus it has an effective function of blowing air. After a period of usage, however, dust will be accumulated on the surface of the fan blades due to the static. To clean it off, the user has to rely on a ladder, moreover, since the fan blades are rigidly and laterally fixed to the rotary assembly, which are susceptible to warp, even possibly be broken in case of great cleaning force.

The present invention has arisen to mitigate and/or obviate the afore-described disadvantages of the conventional ceiling fan blade.

### SUMMARY OF THE INVENTION

The primary object of the present invention is to provide an improved ceiling fan blade structure which enables the user to clean the fan blades easily without damages caused.

Based on the above-mentioned object of the present invention, a fan blade-hoisting device is disposed between each fan blade and the rotary assembly respectively, which enable the respective fan blade to be hung down before the motor is started, such that it can be cleaned by the user easily and without warp or broken caused.

Furthermore, when the motor is started and effect the rotation of rotary assembly as well as the respective fan blade, at the moment, the fan blades will be raised up automatically by virtue of the centrifugal force and the forces acting on the windward side, such that it can push the air while rotating.

On the other hand, the hanging down fan blades surround the pendant lamp below the fan, the light emitting out through the gaps between the respective fan blade makes the ceiling fan assume a special visual effect, so as to meet the demand of integral design of the fan and the pendant lamp.

The present invention will become more obvious from the following description when taken in connection with the accompanying drawings, which shows, for purpose of illustrations only, the preferred embodiments in accordance with the present invention.

### BRIEF DESCRIPTION OF THE DRAWINGS

FIG. 1 is a cross sectional view of a fan blade-hoisting device in accordance with a first embodiment of the present invention;

FIG. 2 is a top view of the fan blade-hoisting device in accordance with the first embodiment of the present invention;

FIG. 3 is a partial amplified view of the fan blade-hoisting device in accordance with the first embodiment of the present invention;

FIG. 4 is a schematic illustrative view of showing the hanging-down status of the fan blade-hoisting device in accordance with the first embodiment of the present invention;

FIG. 5 is a schematic illustrative view of showing the fan blade-hoisting device in accordance with the first embodiment of the present invention being matched with a connecting rod assembly and a power setting;

FIG. 6 is a schematic illustrative view of showing the fan blade-hoisting device being matching with the connecting rod assembly in accordance with the first embodiment of the present invention;

FIG. 7 is a partial schematic illustrative view of a fan blade-hoisting device in accordance with a second embodiment of the present invention;

FIG. 8 is a cross sectional view of showing the fan blade-hoisting device in accordance with the second embodiment of the present invention being matched with a connecting rod assembly and a power setting;

FIG. 9 is a schematic illustrative view of showing the fan blade-hoisting device being matching with the connecting rod assembly in accordance with the second embodiment of the present invention;

### DETAILED DESCRIPTION OF THE PREFERRED EMBODIMENTS

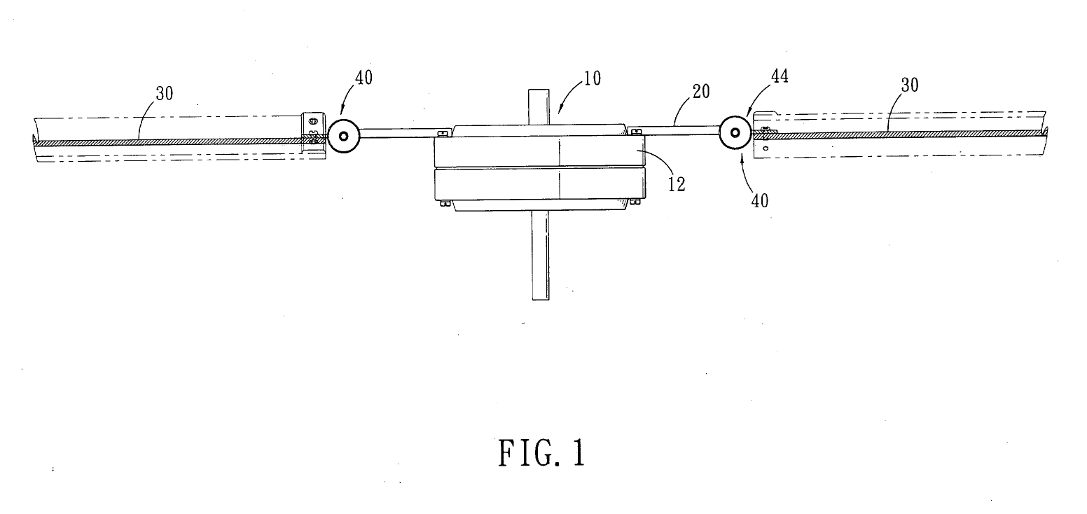

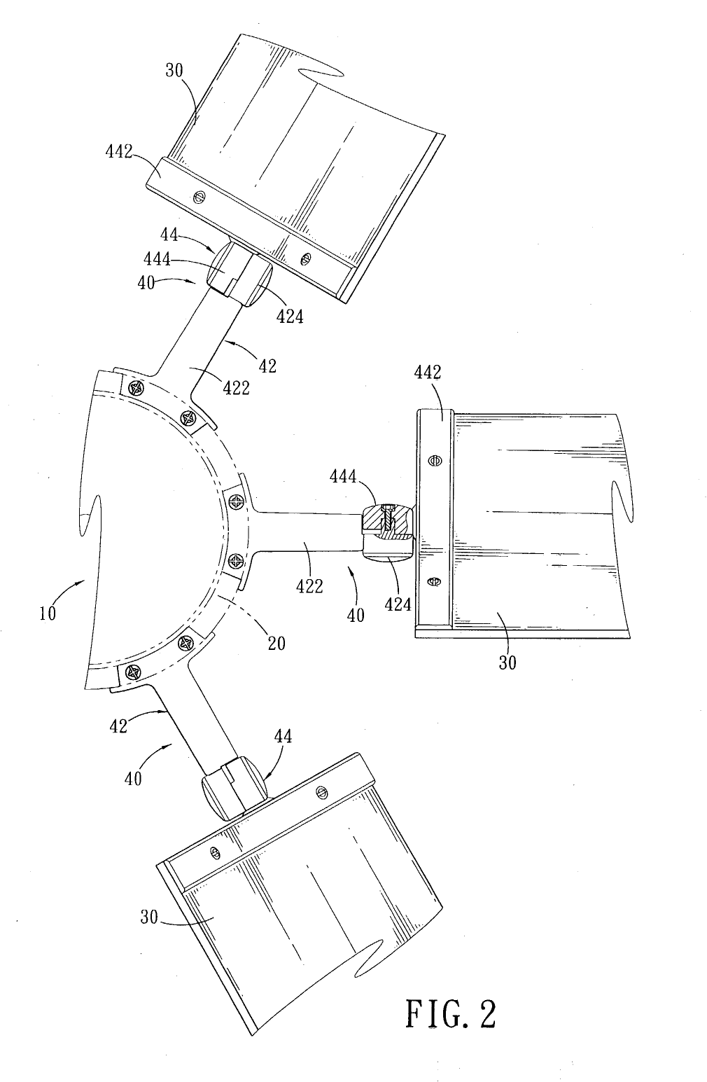

Referring to FIGS. 1-2, a ceiling fan assembly in accordance with the present invention generally includes a motor 10, a rotary assembly 20, a plurality of fan blades 30 and a plurality of hoisting devices 40. The motor 10 is an external-rotor motor and outer periphery of which is disposed with a cover 12, the rotary assembly 20 is fixed to the cover 12 and accordingly rotatable along with the rotation of the motor 10.

For easy and explicit explanation, hereinafter, takes a hoisting device 40 and a blade 30 as example.

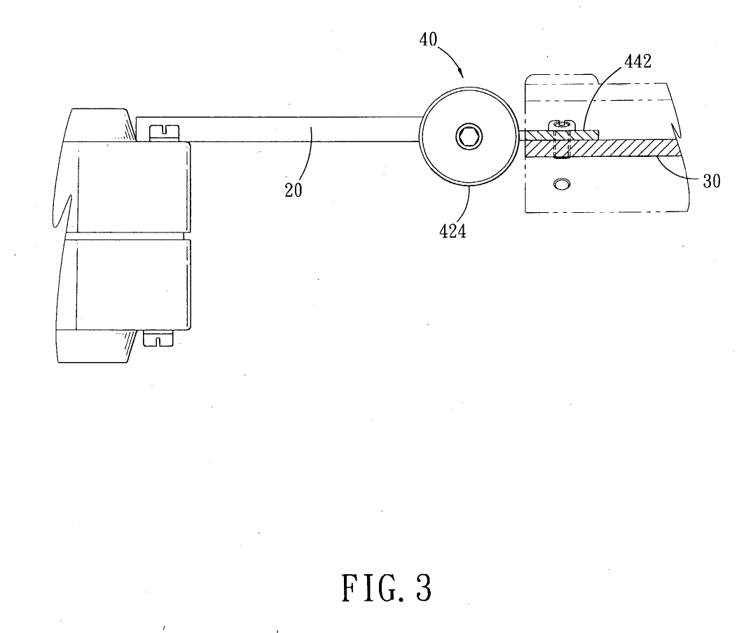

Referring to FIGS. 2-3, wherein the hoisting device 40 includes a fixed bracket 42 and a revolving unit 44. The fixed bracket 42 further comprises a supporting arm 422 and a first coupling portion 424, while the revolving unit 44 has a blade-coupling portion 442 and a second coupling portion 444.

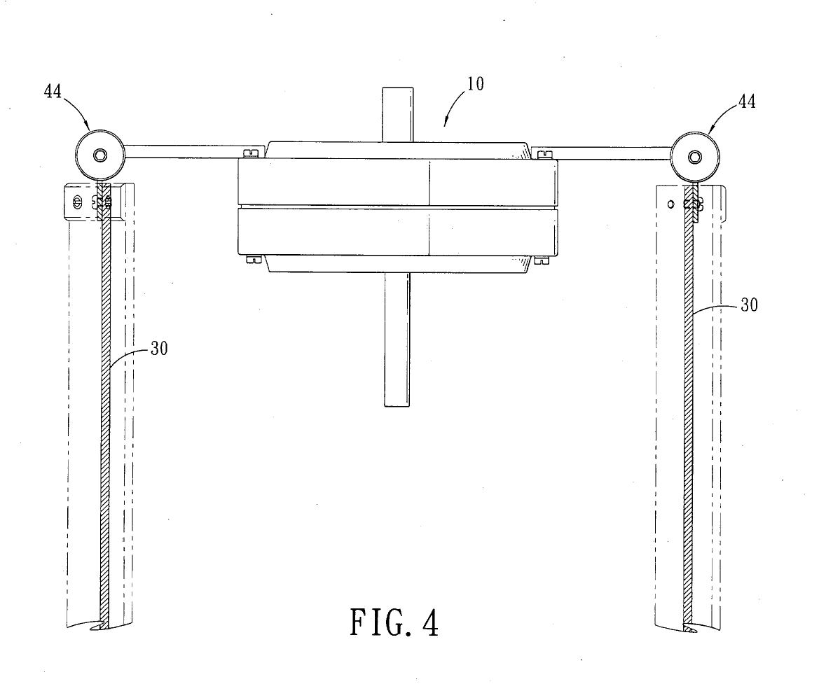

The supporting arm 422 is employed to be fixed to the rotary assembly 20, the first coupling portion 424 is connected to the second coupling portion 444, while the blade-coupling portion 442 serves for fixing the blade 30. It will be noted that the second coupling portion 444 is revolvable relative to the first coupling portion 424. Referring to FIG. 4, which shows, in case of stoppage of the motor 10, the revolving unit 44 will revolve due to the weight of the fan blade 30, which results in a dropping down of the blade 30. At the moment, if turn on the pendant lamp below the ceiling fan (not shown), the light will emit out through the gaps between the fan blades such that produces a special visual effect.

In addition, the user is able to clean the blade 30. At the moment, the surface of the blade 30 is perpendicular to the user's line of sight, thereby the user can do the clean in an very easy way. And the blade 30 will not be warped in cleaning, so as to prevent the deformation as well as broken of the blade 30.

Referring back to FIG. 1, when the motor 10 is started, the rotary assembly 20 and the blade 30 will start to rotate as well. At the moment, the blade 30 is affected both by the centrifugal force and the acting force on the windward side, such that drives the revolving unit 44 of the hoisting device 40 to revolve. In this case, the blade 30 can be raised up automatically and rotated so as to push the air.

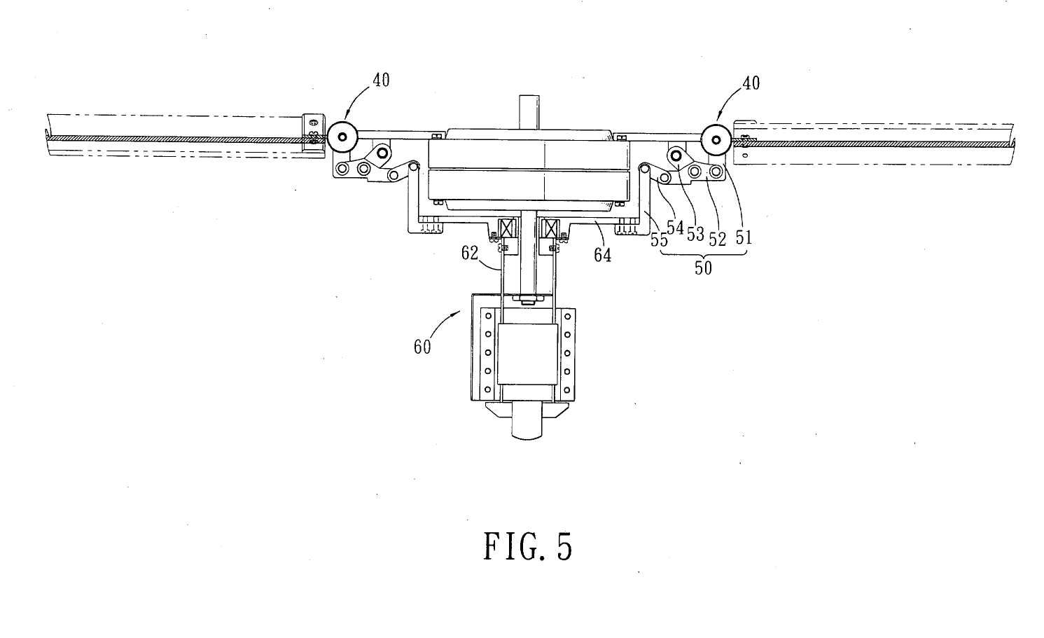

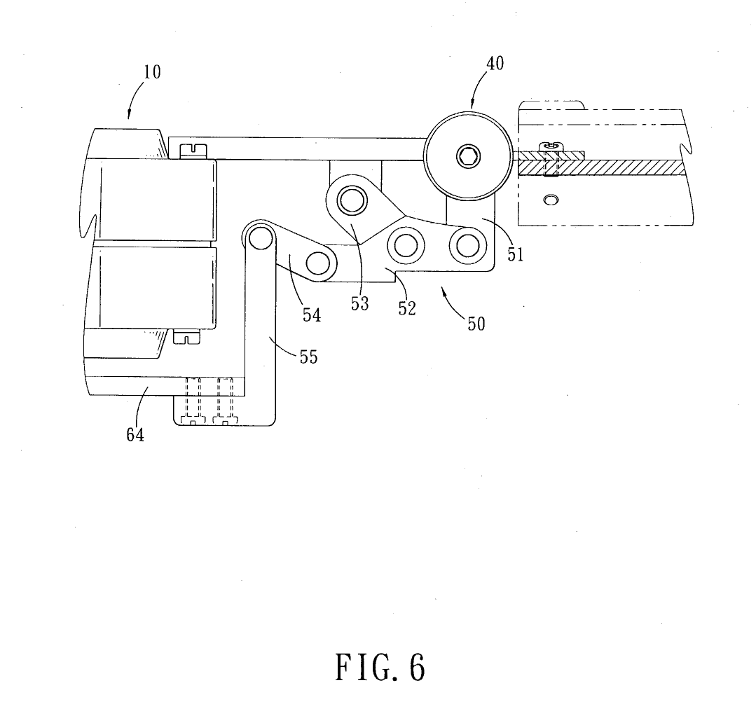

Referring further to FIGS. 5-6, wherein the hoisting device 40 includes a connecting rod assembly 50 and a power setting 60. The connecting rod assembly 50 further includes a first connecting rod 51 for connecting with the revolving unit 44, a second connecting rod 52 for connecting with the first connecting rod 51, a third connecting rod 53 for connecting with the rotary assembly 20 and the midpoint of the second connecting rod 52, a fourth connecting rod 54 for connecting with an end of the second connecting rod 52, a fifth connecting rod 55 for connecting with the fourth connecting rod 54.

The power setting 60 includes an electromagnetic valve switch 62 and a push plate 64. The push plate 64 is fixed to the electromagnetic valve switch 62 and connected with an end of the fifth connecting rod 55.

When the electromagnetic valve switch 62 is actuated to work, the push plate 64 will push the connecting rod assembly 50 so as to raise up the blade 30. By such a manner, the blade 30 will rotate to push the air in case of rotation of the motor 10. In like manner, the blade 30 can be drop down by virtue of the power setting 60 and the connecting rod assembly 50.

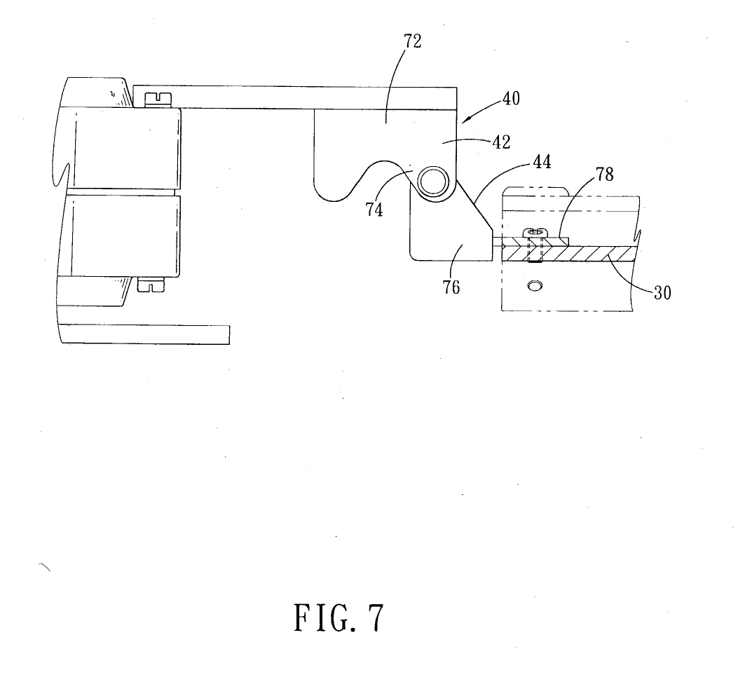

Referring to FIG. 7, which shows a fan blade-hoisting device in accordance with another embodiment of the present invention, wherein the fixed bracket 42 of the hoisting device 40 is made in form of a stand 72. The stand 72 has an end fixed to the rotary assembly 20 and another end defined with a coupling portion 74. The revolving unit 44 is made in form of an oscillating rod 76 having an end connected with the coupling portion 74 and another end formed with a fan blade-coupling portion 78 for coupling with the blade 30.

In case of stoppage of the motor 10, the weight of the blade 30 will drive the oscillating rod 76 to revolve and result in a dropping down of the blade 30. In this case, the user is able to clean the blade 30 easily without damaged caused.

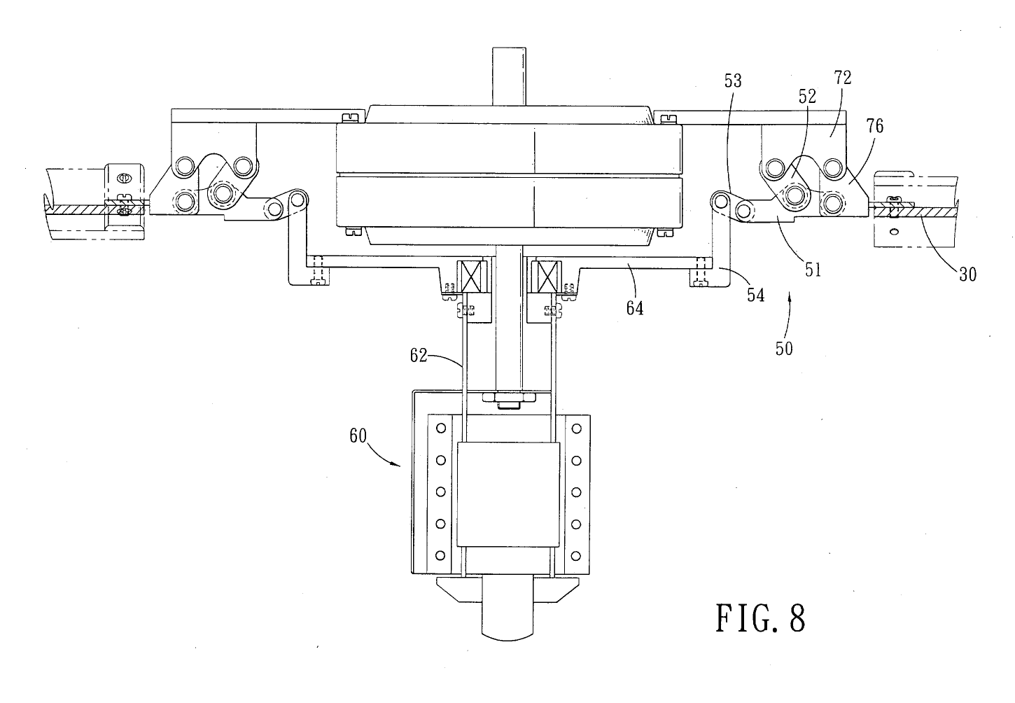

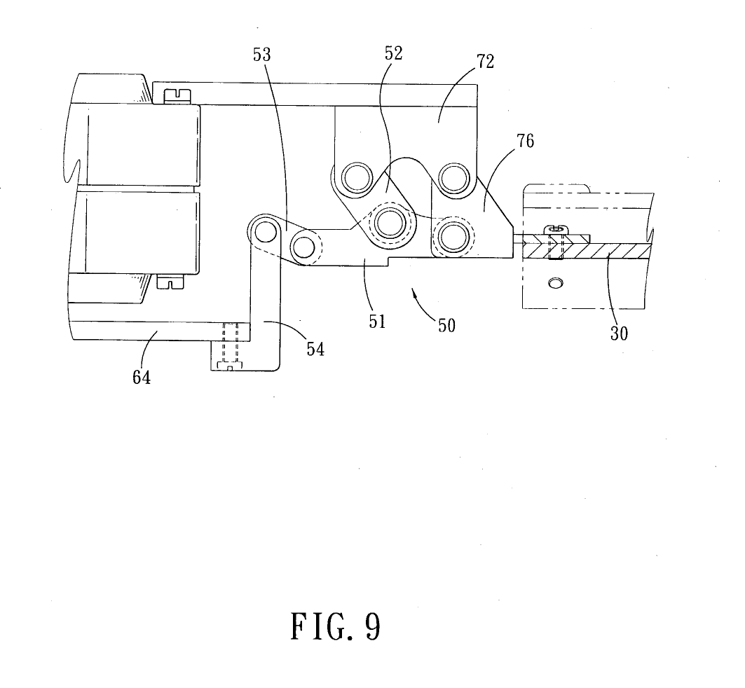

Referring to FIGS. 8-9, wherein a connecting rod assembly 50 and a power setting 60 can be applied to cooperate with the hoisting device 40 consisting of the stand 72 and the oscillating rod 76. The connecting rod assembly 50 includes a first connecting rod 51, a second connecting rod 52, a third connecting rod 53 and a fourth connecting rod 54 respectively. The combining and connecting manner of which is identical to that of the above-mentioned embodiment, so further remarks on this matter would seem superfluous. Furthermore, the power setting 60 includes an electromagnetic valve switch 62 and a push plate 64. Wherein the push plate 64 is fixed to the electromagnetic valve switch 62 and connected with an end of the fourth connecting rod 54.

By such arrangements, when the power setting starts to work, the connecting rod assembly 50 will be actuated to push the connecting rod 76 so as to raise up the fan blade 30, in this case, the fan blade 30 is able to blow the air while rotating.

It is concluded from the above descriptions that the ceiling fan blade 30 of the present invention can be drop down and raised up automatically. The user is able to clean the fan blade 30 easily without damage caused when it is hung down, when the blade 30 is raised up and rotating, it is able to provide cooling effect by blowing the air, so as to meet the effective demand.

While we have shown and described various embodiments in accordance with the present invention, it should be clear to those skilled in the art that further embodiments may be made without departing from the scope of the present invention.

1. A fan blade-hoisting device for ceiling fan disposed between an external-rotary assembly of a motor of the ceiling fan and each fan blade, which comprising:
a fixed bracket fixed to the rotary assembly;
a revolving unit having a first end for coupling to the fixed bracket and a second end for fixing fan blades, in case that the fan blades acted by force on its windward side, the revolving unit and the fixed bracket accordingly producing relative revolution whereby to raise up the fan blades automatically;
wherein the revolving unit further has a connecting rod assembly and the connecting rod has an end connected with a power setting, whereby the power setting enables the connecting rod assembly to drive the revolving unit.

2. The fan blade-hoisting device for ceiling fan as claimed in claim 1, wherein the fixed bracket includes a supporting arm and a first coupling portion, the revolving unit includes a fan blade-coupling portion and a second coupling portion, the supporting arm serving for fixing to the rotary assembly, while the first coupling portion is connected with the second coupling portion, the fan blade-coupling portion is provided for fixing fan blade.

3. The fan blade-hoisting device for ceiling fan as claimed in claim 1, wherein the fixed bracket is a stand member having an end fixed to the rotary assembly and another end formed with coupling portion, the revolving unit is an oscillating rod having an end connected with the coupling portion and another end defined with fan blade-coupling portion for fixing the fan blades.

4. (Cancelled)

5. The fan blade-hoisting device for ceiling fan as claimed in claim 2, wherein the revolving unit further has a connecting rod assembly which has an end connected with a second coupling portion of the revolving unit and another end connected with a power setting, whereby the power setting enables the connecting rod assembly to drive the revolving unit.

6. The fan blade-hoisting device for ceiling fan as claimed in claim 3, wherein on the oscillating rod is defined with a connecting rod assembly which is connected with a power setting, whereby the power setting enables the connecting rod assembly to drive the revolving unit.

7. (Cancelled)
